(19) United States
(12) Patent Application Publication
(10) Pub. No.: US 2020/0017287 A1
(43) Pub. Date: Jan. 16, 2020

(54) PREPACKAGED FLUID FOOD PORTIONS AND METHOD

(71) Applicants: Marta Magnusson, Grimsby (CA); Maxine Magnusson, Grimsby (CA)

(72) Inventors: Marta Magnusson, Grimsby (CA); Maxine Magnusson, Grimsby (CA)

(21) Appl. No.: 16/510,972

(22) Filed: Jul. 14, 2019

Related U.S. Application Data
(60) Provisional application No. 62/698,577, filed on Jul. 16, 2018.

(51) Int. Cl. B65D 85/72; B65D 75/20; A23L 29/20

(52) U.S. Cl. CPC B65D 85/72; A23L 29/20; B65D 75/20

(57) ABSTRACT

A novel configuration for individual pre-packaged portions of fluid foods and a method of preparing them is disclosed. Also disclosed is a method of preparing individual pre-packaged portions of fluid foods wherein a portion of a fluid food, optionally including thickening and/or preservative agents, is extruded into a wrapper in a predetermined portion. The wrapper is then sealed to protect the fluid food portion. Multiple methods, resulting in a variety of configurations of the individual pre-packaged portion of fluid food, are disclosed.

### PRIORITY CLAIM

This application claims priority from one or more previously filed Provisional Patent applications, namely:

U.S. Provisional Patent Application Ser. No. 62/698,577, “PREPACKAGED FLUID FOOD PORTIONS AND METHOD,” filed Jul. 16, 2018.

This invention relates to individual pre-packaged portions for foods and/or condiments which are at least semi-fluid such as jam, jelly, or butter and a method for creating them. By using the method of the invention and proper packaging, these fluid condiments and fluid foods can be pre-packaged into individual portions for use on sandwiches, et cetera.

### BACKGROUND OF THE INVENTION

The present invention relates to pre-packaged individual servings of condiments and/or foods which are at least semi-fluid. While the application of the present invention is not limited to use with sandwiches, analogous individual servings of food for use in sandwiches, such as individual slices of cheese, are well-known in the culinary art. However, many sandwiches benefit from the application of liquid or semi-liquid (collectively, “fluid”) condiments or elements such as dairy-based butter, nut butter like peanut or almond butter, sweet spreads like cocoa and/or hazelnut spreads, or mayonnaise. These may also constitute actual fluid elements of the sandwich, such as ketchup or mustard.

Many such fluid condiments and fluid elements cannot, or at least it is preferred that they should not, be applied in advance because they will soak into the sandwich, rendering it soggy and unappetizing, and making it more likely to break apart while the user attempts to eat it. A means of making the proper amount of fluid condiment(s) and fluid elements available to conveniently add to the sandwich before eating is a useful invention.

Such fluid condiments and fluid elements often require spreaders (e.g. butter knives) to be spread uniformly over the sandwich. Such spreaders must be carried to where the sandwich is to be assembled and require storage space and cleaning resources. A means of applying fluid condiments and fluid elements to sandwiches in a uniform manner without the use of spreaders is a useful invention.

Such fluid condiments and fluid elements are often packaged in dispensers such as squeeze bottles which, if not used carefully or if they experience structural failure, can add too much of the condiment to the sandwich, rendering it soggy and unappetizing. A means of controlling the amount of fluid condiments and fluid elements administered when creating a sandwich is a useful invention.

Many kinds of sandwiches include multiple fluid foods, but to assemble such a sandwich from packaged fluid foods such as peanut butter and jelly, separate containers of peanut butter and jelly must be carried and used to assemble the sandwich. A means of allowing a sandwich using multiple fluid foods to be neatly and conveniently assembled at or near the time of consumption is a useful invention.

Sandwiches are often assembled in bulk for catering, parties, large families, or other purposes. Dispensing and dispersing fluid condiments and fluid elements equally can be difficult and time-consuming. A means of allowing fluid condiments and fluid elements to be added to bulk quantities of sandwiches consistently and conveniently, while allowing individual sandwiches to be customized to the consumer's preference, is a useful invention.

Dispensing liquid or semi-liquid elements or condiments into sandwiches or other food preparations can be difficult for those with motor coordination or other physical difficulties, such as small children, the elderly, or anyone else who might have difficulty holding a (potentially heavy) bottle or container of fluid food and squeezing or pouring it to dispense the appropriate amount of fluid food in the appropriate place, or scooping it from a bottle or container and spreading it with control and precision. A means of allowing fluid condiments and fluid elements to be added to sandwiches easily and conveniently for those with motor coordination or other physical difficulties is a useful invention.

The present invention addresses these concerns.

### SUMMARY OF THE INVENTION

Among the many objectives of the present invention is the provision of pre-packaged individual servings of fluid condiments and fluid foods.

Another objective of the invention is to provide pre-packaged individual servings of fluid condiments and fluid foods which do not need utensils to apply or serve.

Yet another objective of the invention is to provide pre-packaged individual servings of fluid condiments and fluid foods in a pre-sized “slice” format convenient for application to sandwiches et cetera.

A further objective of the invention is to provide pre-packaged individual servings of fluid condiments and/or fluid foods which mix two or more types of fluid condiment and/or fluid food into a single convenient pre-packaged portion.

Still another objective of the invention is to provide pre-packaged individual servings of fluid condiments and fluid foods which allow quick and consistent application of the fluid condiments and fluid foods to sandwiches, et cetera, in bulk.

Another objective of the invention is to provide pre-packaged individual servings of fluid condiments and fluid foods which allows those with motor coordination or other physical difficulties to quickly, consistently and conveniently apply the fluid condiments and fluid foods to sandwiches, et cetera.

Other objectives and advantages of the present invention will become apparent to those of ordinary skill in the art upon review of the disclosure hereof.

### BRIEF DESCRIPTION OF THE DRAWINGS

FIG. 1 depicts an overhead view of the preferred embodiment of the invention in the open position.

FIG. 2 depicts an overhead view of the preferred embodiment of the invention in the sealed position.

FIG. 3 depicts an overhead view of an alternate embodiment of the invention in the open position.

FIG. 4 depicts an overhead view of an alternate embodiment of the invention in the sealed position.

FIG. 5 depicts a flow chart showing the method of the invention.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

For purposes of this invention, the term “fluid food” will be used to refer to any liquid or semi-liquid edible material, by way of example but without limitation including jelly, jam, butter, margarine, sweet spreads such as cocoa and hazelnut spread, salad dressing or mayonnaise. The edible material may be a significant component in a sandwich, such as jelly in a peanut-butter-and-jelly sandwich, applied as a single layer to bread or toast, or it may be a condiment, such as mayonnaise on a bacon, lettuce, and tomato sandwich. It may also be used to apply a condiment or ingredient in a non-sandwich configuration such as applying a layer of sweet spread as a topping or garnish to a dessert.

To be a “fluid food” as that term is used in this application, the edible material must be amorphous (a fluid, even if a very thick fluid) somewhere within a reasonable range of the temperatures and pressures encountered by humans in day-to-day life. It is not required that the edible material be amorphous in the entire range of temperatures and pressures encountered by humans in day-to-day life. By way of example but without limitation, butter, as usually sold in sticks or containers, is a highly malleable solid at common room temperatures, but will, depending on its formulation, gradually become a fluid at temperatures encountered in normal outdoor environments or non-climate-controlled indoor environments during the summer in many parts of the world.

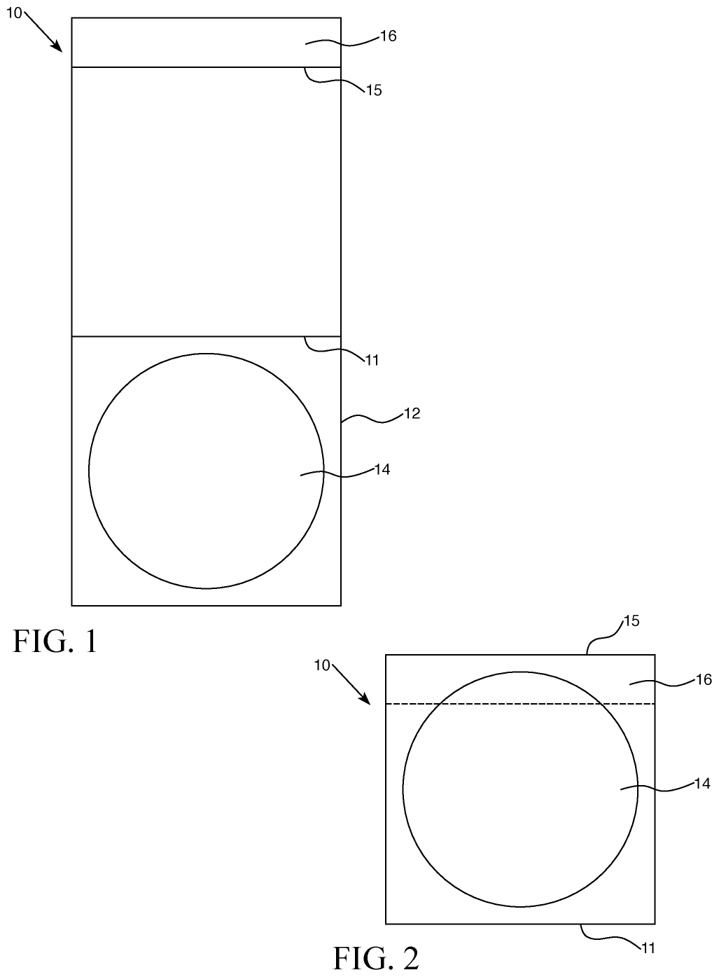

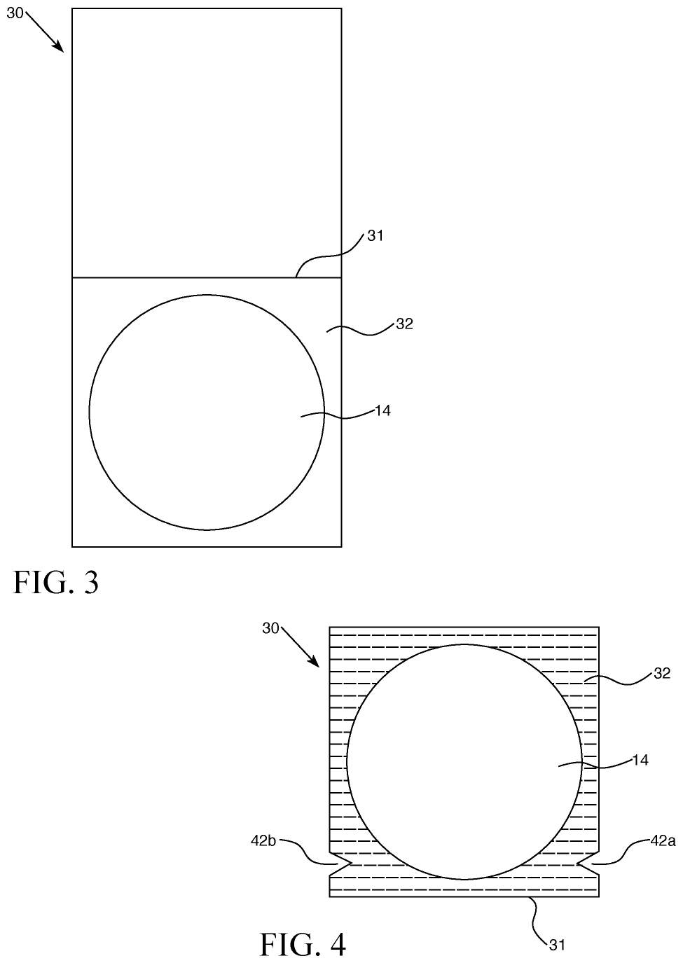

By referring to FIGS. 1 and 2, the preferred embodiment of the pre-packaged individual serving of fluid food can be easily understood. Pre-packaged fluid food portion 10 comprises wrapper 12 and fluid food portion 14. Wrapper 12 folds at first fold 11 and second fold 15 to surround fluid food portion 14. The portion of wrapper 12 defined by fold 15 creates flap 16, which is doubled over the rest of the pre-packaged fluid food portion 10 to allow ease of opening. It is optional to include flap 16: see FIGS. 3 and 4. It is required that the exterior edges of wrapper 12 be hermetically sealed along with flap 16 and that it be essentially nonporous to prevent the fluid food from drying out and/or allowing fluid to diffuse through the wrapper. It is required that wrapper 12 be essentially nonreactive to the fluid food.

FIGS. 3 and 4 show an alternate embodiment of the pre-packaged fluid food portion. Pre-packaged fluid food portion 30 comprises wrapper 32 and fluid food portion 14. Wrapper 32 folds at first fold 31 and is sealed to surround fluid food portion 14. As with the first embodiment (see FIGS. 1 and 2) it is required that the exterior edges of wrapper 32 be hermetically sealed and that it be essentially nonporous to prevent the fluid food from drying out and/or allowing fluid to diffuse through the wrapper. It is required that wrapper 12 be essentially nonreactive to the fluid food.

It is optional, but strongly preferred, for wrapper 12 and wrapper 32 (collectively, “the wrapper”) to comprise a single sheet of material which is folded to surround the fluid food portion 14. This eliminates one possible opening to the outside air and/or way for the fluid food to escape the confinement of the wrapper. If the wrapper comprises more than one piece of material, it is required that the pieces be joined to a food-safe level to surround the fluid food portion and prevent it from escaping the wrapper.

Optional pre-cuts 42a and 42b allow the wrapper to be torn open easily: by pulling at the wrapper near the pre-cuts: due to the nature of most plastics from which the wrapper would reasonably be made, it will tear neatly and easily, allowing access to the fluid food portion. It is optional to include a small unsealed corner portion (not shown) where the wrapper can be pulled apart more easily. This can be done in addition to, or independently of, the use of the pre-cuts.

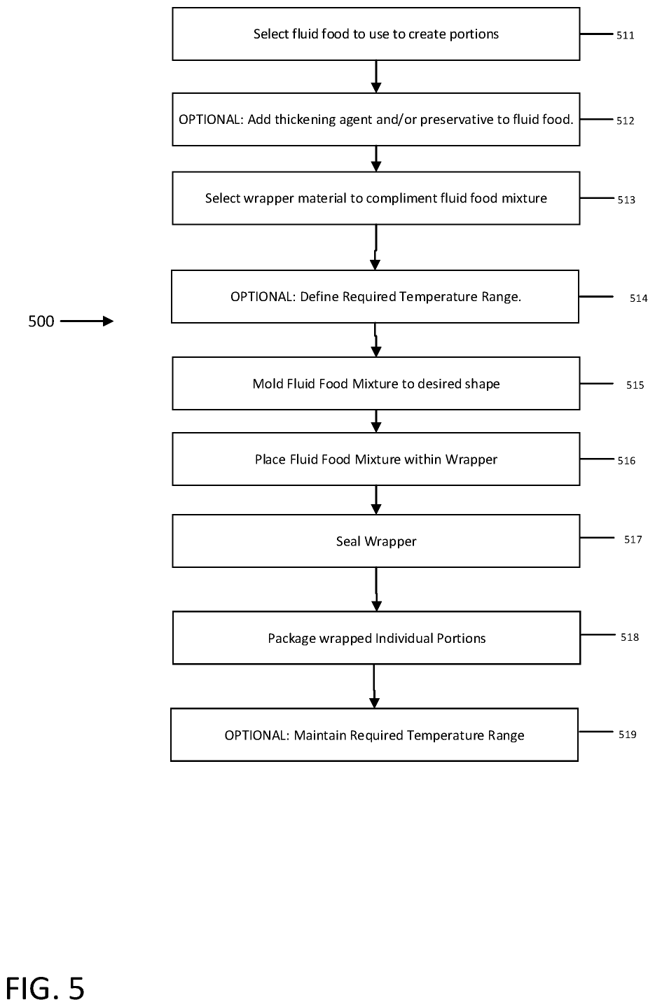

It will be apparent to those of skill in the art that the configuration shown in FIGS. 3 and 4 provides a particularly useful means for those with motor coordination or other physical difficulties to conveniently, easily and consistently use fluid food portions to prepare sandwiches or other food items. All such persons need to do is pull open the wrapper to expose the fluid food portion, and then apply it directly to the location to which they wish to apply the fluid food. It is easy to get at, easy to apply precisely and consistently, and requires no holding and squeezing or pouring from heavy jars or containers. It is also not necessary for them to carefully open and/or re-seal such containers in order to have access to fluid food portions. Such persons can also use the configuration shown in FIGS. 1 and 2, or any pre-packaged fluid food portion prepared with the method of FIG. 5, but this is the preferred configuration to address the concerns of such persons.

It will likewise be obvious to persons of ordinary skill in the art that pre-packaged fluid food portions of various types can be included with either other bulk sandwich ingredients (such as precut breads and rolls, presliced meats and vegetables, et cetera) or with pre-constructed bulk sandwiches to allow consumers at catered events, et cetera, access to a variety of fluid food components for bulk sandwiches without any danger of making the bread soggy, including condiments on a sandwich which a consumer of that particular sandwich may not enjoy, or other negative consequences of adding fluid foods to the sandwich prior to its reception by the consumer.

FIG. 5 depicts the method of preparing the pre-packaged fluid food portion. Method 500 begins with Step 511, selecting a fluid food to use to create pre-packaged fluid food portions.

In optional Step 512, an appropriate thickening agent is added to the fluid food which will allow it to retain its shape within a reasonable range of the temperatures and pressures encountered by humans in day-to-day life, including temperatures typically encountered in food shipment and storage. Note that this step is optional, but strongly preferred. Whether this is done or not from this point on the fluid food will be referred to as the “fluid food mixture.” It is also optional, but nether preferred nor required to add a preservative or preservatives to the fluid food mixture, for reasons which will become apparent in Step 514.

In Step 513, a wrapper material is selected to complement the fluid food mixture. It is required that this wrapper material be food safe, non-porous, durable enough to withstand packaging and transport, and be substantially non-reactive with the fluid food mixture. It is preferred to use a non-fluid-absorbing plastic wrapping foil. Though not specifically described in the preferred embodiment, additional ingredients such as emulsifiers, coloring agents, flavoring agents, nutritional supplements, et cetera may also be added during the execution of the method.

In optional Step 514, a required temperature range is defined, which the fluid food is not allowed to depart from in storage or transport. This temperature range is defined by first defining the required temperature range as a safe temperature range outside of which the fluid food mixture might become unsafe for consumption or degrade and become inedible or unappetizing during a predefined shelf life, and secondly, if the safe temperature range exceeds the temperature range in which the fluid food mixture will retain its shape in the wrapper, reducing the required temperature range to that which will ensure that the fluid food mixture will retain its shape in the wrapper.

The use of a preservative or preservatives in Step 512 will increase the safe temperature range. The use of a thickening agent in Step 512 will increase the temperature range that will ensure that the fluid food mixture will retain its shape in the wrapper. After Step 517, it is required that the prepackaged fluid food portion be kept within the required temperature range at substantially all times such that the temperature of the prepackaged fluid food item does not depart from the required temperature range for more than brief periods of time.

In Step 515, an individual fluid food mixture portion is molded to the desired shape for insertion into the wrapper. This can be done in any reasonable fashion, including but not limited to extrusion, dispensing it in fluid form, molding it into a predefined shape by pressing it into a predefined mold, chilling it to a temperature where it becomes sufficiently solid and slicing it, or many other ways which will be obvious to persons of ordinary skill in the art.

In Step 516, the molded individual fluid food mixture portion is placed within the wrapper. This can be done in any reasonable fashion, including but not limited molding, extruding or slicing it directly on to the wrapper, automatically dispensing it onto the wrapper, picking it up manually or with a robotic or other automatic arm and depositing it onto the wrapper, or many other ways which will be obvious to persons of ordinary skill in the art.

In Step 517, the wrapper is sealed. This can be done in any reasonable fashion, including but not limited to food-safe adhesive, sonic welding, crimping, heating the wrapper to the point where it bonds to itself, or many other ways which will be obvious to persons of ordinary skill in the art. It is required that the method used be food-safe, not significantly disturb the shape of the molded individual fluid food mixture portion, and not cause the temperature of the fluid food mixture to exceed the required temperature range for a period of time long enough to cause the fluid food mixture to become unsafe or degrade.

In Step 518, the pre-packaged individual serving of fluid food is packaged for shipment and sale.

In optional Step 519, if a required temperature range was defined in Step 514, the pre-packaged individual serving of fluid food is maintained within the required temperature range at substantially all times such that the temperature of the prepackaged fluid food item does not depart from the required temperature range for more than brief periods of time.

In an improved embodiment, two or more individual fluid foods can be used to create the individual pre-packaged fluid food portion. This is done by repeating Step 511 for each desired fluid food, such as peanut butter plus jelly. It is required that all fluid foods to be used to create the pre-packaged individual serving of fluid food be compatible physically and with regard to food safety so that they will create a complete pre-packaged individual serving of fluid food which can be stored for a reasonable amount of time and remain safe and edible.

After all the fluid foods have been chosen, and optional Step 512 also repeated if desired for each fluid food, Steps 513-518 are executed as in the previous description, with the selection of the wrapper material and the required temperature range made taking into account the properties of all the fluid foods used to create the pre-packaged individual serving of fluid food. It is optional to mold or otherwise mix the fluid foods in interesting patterns (for example spiraling peanut butter and jelly as concentric spirals meeting at a center point,) as a pure separation (for example, half peanut butter, half jelly), in layers (such as a layer of peanut butter adjacent to a layer of jelly, the layers separated by a fold in the wrapper or other material or else left tangent to each other), or simply to mix them homogenously.

While various embodiments and aspects of the present invention have been described above, it should be understood that they have been presented by way of example only, and not limitation. Thus, the breadth and scope of the present invention should not be limited by any of the above exemplary embodiments.

This application—taken as a whole with the abstract, specification, and drawings being combined—provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device and method can become clear to a person having ordinary skill in this particular art. Such modifications are clearly covered by this disclosure.

What is claimed and sought to be protected by Letters Patent is:

1) A pre-packaged individual serving of fluid food comprising:
a) An individual serving of fluid food; and,
b) A hermetically sealed non-porous wrapper, the hermetically sealed non-porous wrapper containing the individual serving of fluid food in a thin and substantially flat form.

2) A pre-packaged individual serving of fluid food as in claim 1, wherein a thickening agent is added to the fluid food, the thickening agent causing the fluid food to substantially maintain a fixed shape within a temperature range.

3) A pre-packaged individual serving of fluid food as in claim 1, wherein a preservative agent is added to the fluid food, the preservative agent preventing the fluid food from degrading as quickly as the fluid food would otherwise degrade absent the preservative agent.

4) A pre-packaged individual serving of fluid food as in claim 2, wherein a preservative agent is added to the fluid food, the preservative agent preventing the fluid food from degrading as quickly as the fluid food would otherwise degrade absent the preservative agent.

5) A method of preparing a pre-packaged individual serving of fluid food comprising the steps of:
a) Selecting a fluid food;
b) Determining an individual portion size;
c) Selecting a wrapper material, the wrapper material being non-porous and substantially non-reactive to the fluid food;
d) Creating a wrapper from the wrapper material;
e) Dispensing the fluid food in the individual portion size into the wrapper; and,
f) Sealing the wrapper in a food-safe manner to create a pre-packaged individual serving of fluid food.

6) A method of preparing a pre-packaged individual serving of fluid food as in claim 5, comprising the additional steps of:
g) Adding a thickening agent to the fluid food at any time after the step of selecting the fluid food and before the step of sealing the wrapper in a food-safe manner.

7) A method of preparing a pre-packaged individual serving of fluid food as in claim 5, comprising the additional steps of:
g) Adding a preservative agent to the fluid food at any time after the step of selecting the fluid food and before the step of sealing the wrapper in a food-safe manner.

8) A method of preparing a pre-packaged individual serving of fluid food as in claim 7, comprising the additional step of:
h) Adding a thickening agent to the fluid food at any time after the step of selecting the fluid food and before the step of sealing the wrapper in a food-safe manner.

9) A method of preparing a pre-packaged individual serving of fluid food comprising the steps of:
a) Selecting a fluid food;
b) Determining an individual portion size;
c) Selecting a wrapper material, the wrapper material being non-porous and substantially non-reactive to the fluid food;
d) Defining a required temperature range;
e) Creating a wrapper from the wrapper material;
f) Dispensing the fluid food in the individual portion size into the wrapper;
g) Sealing the wrapper in a food-safe manner to create a pre-packaged individual serving of fluid food; and,
h) Maintaining the pre-packaged individual serving of fluid food within the required temperature range.

10) A method of preparing a pre-packaged individual serving of fluid food as in claim 9, comprising the additional steps of:
i) Adding a thickening agent to the fluid food at any time after the step of selecting the fluid food and before the step of sealing the wrapper in a food-safe manner.

11) A method of preparing a pre-packaged individual serving of fluid food as in claim 9, comprising the additional steps of:
i) Adding a preservative agent to the fluid food at any time after the step of selecting the fluid food and before the step of sealing the wrapper in a food-safe manner.

12) A method of preparing a pre-packaged individual serving of fluid food as in claim 11, comprising the additional steps of:
j) Adding a thickening agent to the fluid food at any time after the step of selecting the fluid food and before the step of sealing the wrapper in a food-safe manner.)

13) A pre-packaged individual serving of fluid food as in claim 1, wherein the individual serving of fluid food comprises a plurality of distinct fluid food types.

14) A pre-packaged individual serving of fluid food as in claim 2, wherein the individual serving of fluid food comprises a plurality of distinct fluid food types.

15) A pre-packaged individual serving of fluid food as in claim 3, wherein the individual serving of fluid food comprises a plurality of distinct fluid food types.

16) A pre-packaged individual serving of fluid food as in claim 4, wherein the individual serving of fluid food comprises a plurality of distinct fluid food types.

17) A method of preparing a pre-packaged individual serving of fluid food as in claim 5, comprising the additional steps of:
g) Selecting a second fluid food at any time after the step of selecting the fluid food and before the step of sealing the wrapper in a food-safe manner; and,
h) Dispensing the second fluid food into the wrapper at any time after the step of selecting the second fluid food and before the step of sealing the wrapper in a food-safe manner.

18) A method of preparing a pre-packaged individual serving of fluid food as in claim 8, comprising the additional steps of:
i) Selecting a second fluid food at any time after the step of selecting the fluid food and before the step of sealing the wrapper in a food-safe manner; and,
j) Dispensing the second fluid food into the wrapper at any time after the step of selecting the second fluid food and before the step of sealing the wrapper in a food-safe manner.

19) A method of preparing a pre-packaged individual serving of fluid food as in claim 9, comprising the additional steps of:
i) Selecting a second fluid food at any time after the step of selecting the fluid food and before the step of sealing the wrapper in a food-safe manner; and,
j) Dispensing the second fluid food into the wrapper at any time after the step of selecting the second fluid food and before the step of sealing the wrapper in a food-safe manner.

20) A method of preparing a pre-packaged individual serving of fluid food as in claim 12, comprising the additional steps of:
k) Selecting a second fluid food at any time after the step of selecting the fluid food and before the step of sealing the wrapper in a food-safe manner; and,
l) Dispensing the second fluid food into the wrapper at any time after the step of selecting the second fluid food and before the step of sealing the wrapper in a food-safe manner.
